(19) United States
(12) Patent Application Publication
(10) Pub. No.: US 2010/0083189 A1
(43) Pub. Date: Apr. 1, 2010

(54) METHOD AND APPARATUS FOR SPATIAL CONTEXT BASED COORDINATION OF INFORMATION AMONG MULTIPLE DEVICES

(76) Inventors: Robert Michael Arlein, Maplewood, NJ (US); James Robert Ensor, Red Bank, NJ (US); Robert Donald Gaglianello, Little Silver, NJ (US); Markus Andreas Hofmann, Fair Haven, NJ (US); Dong Liu, Warren Township, NJ (US)

Correspondence Address: WALL & TONG, LLP/;ALCATEL-LUCENT USA INC., 595 SHREWSBURY AVENUE, SHREWSBURY, NJ, 07702, US

(21) Appl. No.: 12/241,699

(22) Filed: Sep. 30, 2008

(51) Int. Cl. G06F 3/048

(52) U.S. Cl. 715/863

(57) ABSTRACT

The invention includes a method and apparatus for coordinating transfer of information between ones of a plurality of devices including a coordinating device and at least one other device. In one embodiment, a method includes detecting selection of an item available at a first one of the devices, detecting a gesture-based command for the selected item, identifying a second one of the devices based on the gesture-based command and a spatial relationship between the coordinating device and the second one of the devices, and initiating a control message adapted for enabling the first one of the devices to propagate the selected item toward the second one of the devices. The control message is adapted for enabling the first one of the devices to propagate the selected item toward the second one of the devices. The first one of the devices on which the item is available may be the coordinating device or another device.

### FIELD OF THE INVENTION

The invention relates to the field of information transfer and, more specifically, to coordinating transfer of information among multiple devices.

### BACKGROUND OF THE INVENTION

In common practice, information is transmitted between devices and, further, during transmission of information between devices the information is processed by multiple devices. The movement and processing of data among multiple devices is sometimes coordinated by computer programs executing on one or more coordinating devices. The computer programs typically function under the guidance of human-generated commands which are input into the coordinating device. For example, a person may use touch tone inputs on a cellular phone to cause a home digital video recorder to record a specified television program. Disadvantageously, however, existing methods of transmitting information between devices are limited.

### SUMMARY OF THE INVENTION

Various deficiencies in the prior art are addressed by a method and apparatus for coordinating transfer of information between ones of a plurality of devices including a coordinating device and at least one other device. In one embodiment, a method includes detecting selection of an item available at a first one of the devices, detecting a gesture-based command for the selected item, identifying a second one of the devices based on the gesture-based command and a spatial relationship between the coordinating device and the second one of the devices, and initiating a control message adapted for enabling the first one of the devices to propagate the selected item toward the second one of the devices. The control message is adapted for enabling the first one of the devices to propagate the selected item toward the second one of the devices. The first one of the devices on which the item is available may be the coordinating device or another device.

### BRIEF DESCRIPTION OF THE DRAWINGS

The intent of the present invention can be readily understood by considering the following detailed description in conjunction with the accompanying drawings, in which:

FIG. 1 depicts a high-level block diagram of a location including multiple devices;

FIG. 2 depicts the environment of FIG. 1, illustrating an exemplary transfer of information between ones of the multiple devices;

FIG. 3 depicts the environment of FIG. 1, illustrating an exemplary transfer of information between ones of the multiple devices;

FIG. 4 depicts the environment of FIG. 1, illustrating an exemplary transfer of information between ones of the multiple devices;

FIG. 5 depicts the environment of FIG. 1, illustrating an exemplary transfer of information between ones of the multiple devices;

FIG. 6 depicts a method for transferring information between devices using spatial relationships between the devices and one or more gesture-based commands; and

FIG. 7 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

An information transfer coordination capability is provided. The information transfer coordination functions depicted and described herein facilitate coordination of information transfers between devices using spatial relationships between the devices and gesture-based commands. The information transfer coordination functions create a new form of user interface experience, creating an easy-to-use and convenient means for coordination of actions across multiple devices, including manipulation of information across multiple devices. The information transfer coordination functions facilitate use of intuitive and easy-to-remember gesture-based commands to control the manipulation of information across multiple devices.

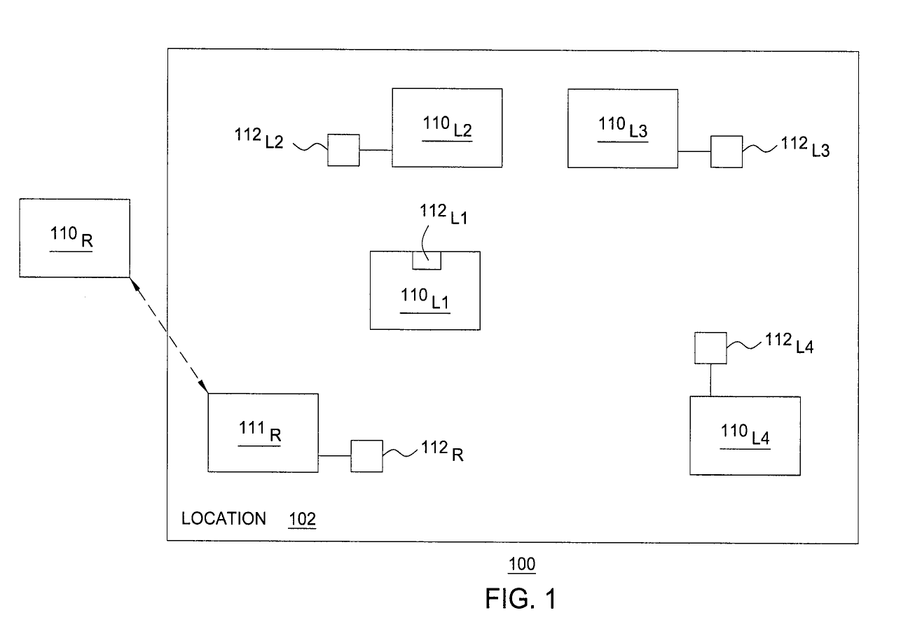

FIG. 1 depicts a high-level block diagram of an environment including a location 102 having multiple devices located thereat. The depiction of location 102 is a top-down view from above the location 102. The location 102 may be any location, such as a room or rooms in a home, an office, a business, and the like. As depicted in FIG. 1, location 102 includes a plurality of local devices 110_{L1}, 110_{L2}, 110_{L3}, and 110_{L4} (collectively, local devices 110_{L}). The location 102 also includes a proxy object 111_{R} that is physically located at location 102, but which is meant to represent a remote device 110_{R} that is not physically located at location 102. The local devices 110_{L} and remote device 110_{R} will be referred to more generally herein as devices 110.

As depicted in FIG. 1, one of the devices operates as a coordinating device (illustratively, local device 110_{L1}). The coordinating device is typically a portable device, although portability of the coordinating device is not required. The coordinating device is capable of presenting information, such as text, audio, images, video, and the like. The coordinating device is capable of receiving and/or sending information to other devices, either directly via point-to-point connections or indirectly via one or more network connections. For example, the coordinating device may be a user device, such as a mobile phone, a personal digital assistant (PDA), a remote control, or another similar device adapted for performing the coordinated information transfer functions depicted and described herein. In the example depicted in FIG. 1, assume that coordinating device 110_{L1} is a PDA having a touch screen.

As depicted in FIG. 1, local devices not operating as the coordinating device include devices capable of being controlled by the coordinating device (illustratively, where the other devices 110_{L2}, 110_{L3}, 110_{L4}, and 110_{R} are capable of being controlled by the coordinating device 110_{L1}). The other local devices are capable of presenting information, such as text, audio, images, video, and the like. The other local devices are capable of receiving and/or sending information to other devices, either directly via point-to-point connections or indirectly via one or more network connections. The other local devices may be stationary or portable devices. For example, the other local devices may include computers, television systems (e.g., set top box, digital video recorder, television, audio system, and the like), game consoles, stereos, cameras, appliances, and the like. In the example depicted in FIG. 1, assume that local device 110_{L2} is a stereo, local device 110_{L3} is a television system, and local device 110_{L4} is a computer.

As depicted in FIG. 1, a remote device also may be controlled by the coordinating device (illustratively, where remote device 110_{R} is capable of being controlled by the coordinating device 110_{L1}, via the proxy object 111_{R} that is physically located at location 102 but which is meant to represent the remote device 110_{R} that is not physically located at location 102). The remote device may be any device capable of storing, sending, receiving, and/or presenting information, such as a cellular phone, a television system, a computer, and the like. The remote device may be stationary or portable. In the example depicted in FIG. 1, assume that remote device 110_{R} is a computer located at the office of the user who lives at location 102.

As depicted in FIG. 1, proxy object 111_{R} provides a local representation of remote device 110_{R}. The proxy object 111_{R} may include any object which the user may choose to use as a representation of remote device 110_{R}.

In one embodiment, proxy object 111_{R} is an object that is incapable of communicating with the other objects 110. For example, the proxy object 111_{R} may be the user's car keys, the user's briefcase, or any other object which the user would like to use to represent remote device 110_{R}. In such embodiments, in order for the proxy object 111_{R} to represent remote device 110_{R}, and to enable coordinating device 110_{L1} to control remote device 110_{R}, proxy object 111_{R} includes means by which coordinating device 110_{L1} may recognize proxy object 111_{R}, such as affixing an RFID tag to proxy object 111_{R}, or any other similar means by which coordinating device 110_{L1} may recognize proxy object 111_{R}.

In one embodiment, proxy object 111_{R} is an object that is capable of communicating with the other objects 110. For example, the proxy object 111_{R} may be a more sophisticated device that is capable of transmitting and receiving information to and from other objects 110. For example, the proxy object 111_{R} may be similar to a modem, set top box, or other device which may be placed at location 102 to represent the remote device 110_{R}. In one embodiment, proxy object 111_{R} may be capable of registering itself with one or more of the devices 110. In one embodiment, the proxy object 111_{R} may be networked. In one embodiment, the proxy object 111_{R} may have a transmitter/sensor associated therewith.

As described herein, the coordinating device 110_{L1} is adapted for controlling each of the other devices 110_{L}, including coordinating transfer of information between any combinations of devices 110. The coordinating device 110_{L1} is adapted for coordinating transfer of information from a source device (any of the devices 110) to one or more target devices (any of the devices 110). The coordinating device 110_{L1} coordinates the transfer of information between devices by identifying information on the source device, selecting at least a portion of the identified information, and controlling propagation of the selected information to one or more target devices.

The coordinating device 110_{L1}, in conjunction with other devices 110, coordinates transfer of information, which may include data items, content items, applications, services, and the like, as well as various combinations thereof. These different types of information may be more generally referred to herein as items. For example, coordinating device 110_{L1} may coordinate transfers of items such as audio clips, pictures, video clips, television shows, movies, software, services, and the like, as well as various combinations thereof.

The coordinating device 110_{L1}, in conjunction with other devices 110, coordinates transfer of information between devices 110 using a combination of information indicative of spatial relationships between the devices 110 and one or more gesture-based commands detected by coordinating device 110_{L1}.

The spatial relationships between devices 110 may be determined in any manner.

In one embodiment, spatial relationships between devices 110 may be determined using absolute spatial information. The absolute spatial information may include identification of locations of devices 110 within an absolute coordinate system, specifics of the absolute coordinate system within which locations of devices 110 are specified, and like information which may be used to determine spatial relationships between devices 110.

In embodiments using absolute spatial information, spatial relationships between devices 110 may be determined using spatial locations of devices 110. The spatial locations of devices 110 may be determined in any manner. In one embodiment, spatial locations of devices 110 may be determined manually. In one embodiment, spatial locations of devices 110 may be determined automatically (e.g., using GPS capabilities or in any other suitable manner for determining spatial locations of devices 110).

In embodiments using absolute spatial information, the spatial locations of devices 110 may be specified in any manner.

In one embodiment, for example, spatial locations of devices 110 may be specified using a coordinate system specific to the location 102 at which devices 110 are located. In this embodiment, the coordinate system specific to the location 102 may be specified in advance (e.g., configured by a user). The absolute coordinate system may be two-dimensional or three-dimensional. The absolute coordinate system may be oriented in any manner. In the example of FIG. 1, an absolute coordinate system is oriented such that the center of the coordinate system is located at the southwest corner of the room, with the abscissa axis running along the southern wall of the room and the ordinate axis running along the western wall of the room (and, optionally, a third axis which specifies the height of devices 110 within the room). The spatial location of a device 110 may be specified using values of the absolute coordinate system (e.g., using x-y coordinates or using x-y-z coordinates).

In another embodiment, for example, spatial locations of devices 110 may be specified using a coordinate system that is independent of the location 102 at which devices 110 are located. For example, spatial locations of the devices 110 may be specified using GPS coordinates or other similar means of specifying location.

The spatial locations of devices 110 may be stored on one or more of the devices 110. For example, the spatial location determined for a device 110 may be configured on that device 110 and advertised by that device 110 to other devices 110 in the vicinity (e.g. automatically, as needed, and the like). For example, the spatial location determined for a device 110 may be configured on the coordinating device 110 which will then provide the spatial location to other ones of the devices 110 (e.g. automatically, as needed, and the like).

The spatial locations of devices 110 may be stored on one or more other devices, either in addition to being stored on one or more of the devices 110 or in place of being stored on one or more of the devices 110. The one or more other devices may be located locally at location 102 or may be located remotely from the location 102.

In embodiments using absolute spatial information, the spatial location of a device 110 may be determined, stored, and disseminated in various other ways.

In one embodiment, spatial relationships between devices 110 may be determined using relational spatial information. In this embodiment, relational spatial information may be obtained using transmitters/sensors adapted for obtaining such information. For example, relational spatial information may be obtained using one or more of optical energy (e.g., infrared (IR) energy, light energy, and the like), radio energy (e.g., radio frequency identifier (RFID) tags, Wireless Fidelity (WiFi), and the like), and the like, as well as various combinations thereof. The transmitters/sensors used to determine relational spatial information may be built into the devices 110 and/or may be separate devices co-located with respective devices 110. In the example, of FIG. 1, the transmitters/sensors used to determine relational spatial information between devices 110 include a built-in transmitters/sensors 112_{L1} that is built into coordinating device 112_{L1} and separate transmitters/sensors 112_{L2}, 112_{L3}, 112_{L4}, and 112_{R} which are co-located with other devices 110_{L2}, 110_{L3}, 110_{L4}, and proxy object 111_{R}, respectively. The transmitters/sensors 112_{L1}-112_{L4} and 112_{R} may be more commonly referred to herein as transmitters/sensors 112.

The relational spatial information may be obtained using any other means for determining spatial relationships between devices 110.

In one embodiment, spatial relationships between devices 110 may be determined using both spatial locations of devices 110 (e.g., from an absolute coordinate system) and relational spatial information associated with devices 110 (e.g., as obtained from transmitters/sensors).

The spatial relationships between devices 110 may be determined by coordinating device 110_{L} in a centralized fashion. The spatial relationships between devices 110 may be determined in a distributed fashion and reported to coordinating device 110_{L1} by others of the devices 110 (e.g., periodically and/or aperiodically). The spatial relationships between devices 110 may be made available to coordinating device 110_{L1} in any manner.

The spatial relationships between devices 110 may be updated periodically and/or aperiodically (e.g., in response to one or more trigger conditions). The spatial relationships between devices 110 may be monitored continuously.

The coordinating device 110_{L1} coordinates transfer of information between devices 110 using one or more gesture-based commands detected by coordinating device 110_{L1}.

A gesture-based command is a command initiated by a user of the coordinating device 110_{L1}. A gesture-based command may specify one or more parameters associated with the transfer of information between devices 110.

A gesture-based command may specify one or more of the devices involved in the transfer (e.g., one or more source devices and/or one or more target devices). A gesture-based command may specify the information to be transferred (e.g., using one or more interactions with one or more user interfaces of coordinating device 110_{L1}). A gesture-based command may specify an operation to be performed for the information (e.g., transferring the information, pre-processing and transferring the information, transferring and post-processing the information, and the like. A gesture-based command may specify any other details which may be utilized to coordinate a transfer of information.

The numbers and types of information transfer parameters that may be expressed in a gesture-based command may be dependent on a number of factors, such as the type of information transfer to be performed, the numbers and types of devices involved in the information transfer, the implementation of the coordinating device (e.g., display capabilities, type of user interface supported, and the like), and the like, as well as various combinations thereof

A single gesture-based command may specify one information transfer parameter (or even a subset of the information associated with an information transfer parameter) or multiple information transfer parameters. As such, depending on the specifics of the information transfer to be performed (e.g., type of information to be transferred, number and type of devices involved, and the like), information sufficient for coordinating device 110_{L1} to initiate the information transfer may be determined from one gesture-based command or from a combination of multiple gesture-based commands.

The gesture-based commands may be configured to perform different functions, such as selecting a device or devices, determining an item or items available from a selected device, selecting an item or items available from a selected device, initiating transfer of selected ones of available items to a selected device, and the like. The gesture-based commands also may be configured to perform different combinations of such functions, as well as other functions associated with coordinating transfers of information between devices.

The gesture-based commands may be defined in any manner, and, thus, a single gesture-based command may be configured to perform multiple such functions. For example, execution of a single gesture-based command may result in selection of a device and determination of items available from the selected device. For example, execution of a single gesture-based command may result in selection of an item available from a source device and initiation of propagation of the selected item from the source device to a target device.

The gesture-based commands may be detected in many ways.

In one embodiment, the gesture-based commands may be detected by the coordinating device 110_{L1}. The gesture-based commands that may be detected by coordinating device 110_{L1} may be based on one or more of an orientation of coordinating device 110_{L1} (e.g., spatially with respect to itself, with respect to one or more of the other devices 110, and the like), a motion detected on a user interface of the coordinating device 110_{L1} (e.g., where a user slides a finger or a stylus in a certain direction across a screen of the coordinating device 110_{L1}, where a user rolls a track ball or mouse in a manner indicating a direction, and the like), a motion of the coordinating device 110_{L1} (e.g., such as where the coordinating device 110_{L1} includes an accelerometer and the user moves the coordinating device 110_{L1} with a particular orientation, direction, speed, and the like), and the like, as well as various combinations thereof. The gesture-based commands also may be detected by coordinating device 110_{L1} using automatic gesture recognition capabilities supported by the coordinating device 110_{L1}.

The gesture-based commands may include associated actuation of one or more controls via a user interface of the coordinating device 110_{L1}. For example, a user may actuate one or more controls via a user interface of the coordinating device 110_{L1} contemporaneous with orientation of coordinating device 110_{L1} and/or motion associated with coordinating device 110_{L1} In this case, the command consists of a combination of the orientation/motion and the associated actuation of one or more controls. The one or more controls may include one or more of pressing one or more buttons on a user interface, one or more selections on a touch screen (e.g., using a finger, stylus, or other similar means), and the like, as well as various combinations thereof. The manner in which the controls are actuated may depend on the type of device used as coordinating device 110_{L1}.

For example, the user may actuate one or more controls via a user interface of the coordinating device 110_{L1} while the coordinating device 110_{L1} is pointed in a certain direction (e.g. at one of the other devices 110). As an example, the user may point the coordinating device 110_{L1} at one of the other devices 110 and press one or more buttons available on the user interface of coordinating device 110_{L1} in order to retrieve a list of items available from the device 110 at which coordinating device 110_{L1} is pointed, such that the list of items available from the device 110 at which the coordinating device 110_{L1} is pointed is displayed on the coordinating device 110_{L1}. As an example, the user may point the coordinating device 110_{L1} at one of the other devices 110 and press one or more buttons available on the user interface of coordinating device 110_{L1} in order to initiate transfer of an item from a source device 110 on which the selected item is stored to the device 110 at which coordinating device 110_{L1} is pointed (which is referred to as the target device 110).

For example, the user may use a combination of actuation of one or more controls via a user interface of the coordinating device 110_{L1} and a corresponding motion detected on the user interface of the coordinating device 110_{L1}. As an example, the user may select an item displayed on a display screen of coordinating device 110_{L1} by pressing a finger against the display screen of coordinating device 110_{L1}, and then drag the selected item to one of the edges of the display screen by sliding the finger over the display screen toward one of the edges of the display screen of coordinating device 110_{L1}, thereby causing the selected item to be transferred from the device on which the item is stored to one or more devices 110 located in the direction of the edge of the display screen of coordinating device 110_{L1} to which the item is dragged.

For example, the user may use a combination of actuation of one or more controls via a user interface of the coordinating device 110_{L1} and a corresponding motion of the coordinating device 110_{L1}. As an example, the user may select an item displayed on a display screen of coordinating device 110_{L1} (e.g., by pressing a finger against the display screen of coordinating device 110_{L1}) and then move the coordinating device 110_{L1} in the direction of one of the other devices (e.g., by flicking coordinating device 110_{L1} in that direction), thereby causing the selected item to be transferred from the device on which the item is stored to one or more devices 110 located in the direction in which coordinating device 110_{L1} is moved.

Although the preceding examples are primarily depicted and described within the context of embodiments in which gesture-based commands include actuation of one or more controls on user interface of the coordinating device 110_{L1}, as described herein, gesture-based commands also may be defined such that no actuation of controls on the user interface of the coordinating device 110_{L1} is required.

In one embodiment, the gesture-based commands may be detected by one or more devices other than coordinating device 110_{L1}, where such other devices include automatic gesture recognition capabilities. The other devices may include others of the devices 110 and/or other devices (e.g., sensors 112 and/or other devices which are not depicted herein) that may be deployed for automatically recognizing gesture-based commands. In this embodiment, detection of gesture-based commands by other devices is communicated from the other devices to coordinating device 110_{L1} for use by coordinating device 110_{L1} in performing the information transfer capabilities depicted and described herein.

For example, the user may point the coordinating device 110_{L1} in the direction of one of the other devices 110, such that the pointing motion may be detected by the other device 110 using automatic gesture recognition capabilities. For example, the user may move his some using some gesture which may be detected by one or more of the other devices 110 using automatic gesture recognition capabilities. The devices 110 may detect various other gestures using automatic gesture recognition capabilities.

As an example, the user may select an item displayed on a display screen of coordinating device 110_{L1} by pressing a finger against the display screen of coordinating device 110_{L1}. The user may then move his hand in a direction toward another one of the devices 110 (e.g., device 110_{L3}). The other device 110_{L3} may, using its automatic gesture recognition capabilities, recognize the gesture as an indication that the user would like to transfer the selected item to device 110_{L3}. The device 110_{L3} may then signal coordinating device 110_{L1} with this information. The coordinating device 110_{L1}, in response to the signaling received from device 110_{L3}, initiates transfer of the selected item from the device on which the item is stored to device 110_{L3} which detected the gesture.

As another example, the user may select an item displayed on a display screen of coordinating device 110_{L1} by pressing a finger against the display screen of coordinating device 110_{L1}. The user may then move his hand in a direction toward another one of the devices 110, e.g., toward device 110_{L3}, to indicate that the item is to be transferred to device 110_{L3}. This gesture indicating that the item is to be transferred to device 110_{L3} may be detected by one or more other devices, e.g., using a combination of automatic gesture recognition capabilities supported by devices 110_{L2} and 110_{L4} as well as some communications between devices 110_{L2} and 110_{L4} by which those devices may resolve the meaning of the detected gesture. The device 110_{L2} and/or the device 110_{L4} may then signal the coordinating device 110_{L1} with this information. The coordinating device 110_{L1}, in response to the signaling received from devices 110_{L2} and/or 110_{L4}, initiates transfer of the selected item from the device on which the item is stored to the device 110_{L3} that was indicated by the detected and recognized gesture.

Although primarily depicted and described with respect to specific examples, automatic gesture recognition capabilities may be used in various other ways to detect and interpret gesture-based commands.

In this manner, for transferring information between devices, a gesture-based command or combination of gesture-based commands may be used to specify the device(s) involved in the transfer of information, the information to be transferred, the operation(s) to be performed, and the like, as well as various combinations thereof, and, further, the gesture-based command(s) may be specified using one or more of a location of the coordinating device, an orientation of the coordinating device, a motion on the coordinating device, a motion of the coordinating device, automatic gesture recognition capabilities (e.g., supported by any device or combination of devices), one or more manual actions initiated by a user via one or more user interfaces of the coordinating device (e.g., button presses, selections on a touch screen, or any other manual user interactions by the user on the coordinating device), and the like, as well as various combinations thereof.

The gesture-based commands may be configured in various other ways to perform various other functions and combinations of functions.

Although primarily depicted and described herein within the context of embodiments in which spatial relationships between devices 110 may be used to interpret gesture-based commands (e.g., to determine that by sliding a thumbnail of an image to a particular side of a touch screen of coordinating device 110_{L1} while coordinating device 110_{L1} is oriented in a particular way, the user intended the image to be transferred to a device 110 located in the direction of the side of the touch screen to which the image was slid), in some embodiments spatial relationship information may be determined using one or more gesture-based commands. As an example, where a user points the coordinating device 110_{L1} in the direction of one of the devices 110 and initiates some action (e.g., pressing one or more buttons on a user interface of the coordinating device 110_{L1}), the spatial relationship between coordinating device 110_{L1} and the one of the devices 110 at which coordinating device 110_{L1} is pointed may be determined therefrom. It will be appreciated that this is just one example of the manner in which relationship information may be determined using one or more gesture-based commands.

Thus, spatial relationships between devices 110 may be determined within the context of one or more gesture-based commands and/or one or more gesture-based command may be detected, analyzed, and/or otherwise processed using spatial relationships between devices 110. The various ways in which coordinating device 110_{L1} may use combinations of spatial relationship information and gesture-based commands is described further hereinbelow.

The coordinating device 110_{L1} coordinates transfer of information between devices 110, which may be facilitated by enabling devices 110 to discover, recognize, and associate with each other and, optionally, to exchange capability information with each other. For example, at least a portion of the devices 110 may utilize Digital Living Network Alliance (DLNA) capabilities, Universal Plug and Play (UPnP) capabilities, and like capabilities in order to enable devices 110 to discover, recognize, and associate with each other and, optionally, to exchange capability information with each other. This may be performed by all of the devices 110 or a subset of the devices 110.

The information propagated between devices 110 may be propagated in any manner.

A source device 110 may propagate an item to a target device 100 using a direct, point-to-point connection. For example, a source device 110 may propagate an item to a target device 110 via a DLNA-based link, a UPnP-based link, and the like, as well as various combinations thereof.

A source device 110 may propagate an item to a target device 100 using an indirect network connection. For example, a source device 110 may propagate an item to a target device 110 via a local area network to which the source and target devices are connected (e.g., wireline or wireless), via the Internet, and the like, as well as various combinations thereof.

For purposes of clarity in describing information transfer coordination functions, it is sufficient to say that some communications path exists, or may be established as needed, between a source device 110 and a target device 110 such that a selected item may be propagated therebetween. Therefore, although omitted for purposes of clarity, at least one communication path exists or may be established between each of the devices 110.

Although primarily depicted and described with respect to use of information transfer coordination functions in a home location having specific numbers and configurations of devices, information transfer coordination functions may be utilized in various other locations having other numbers and configurations of devices. Although primarily depicted and described herein with respect to use of one coordinating device 110_{L1}, multiple coordinating devices may be used, either independently or in conjunction with each other.

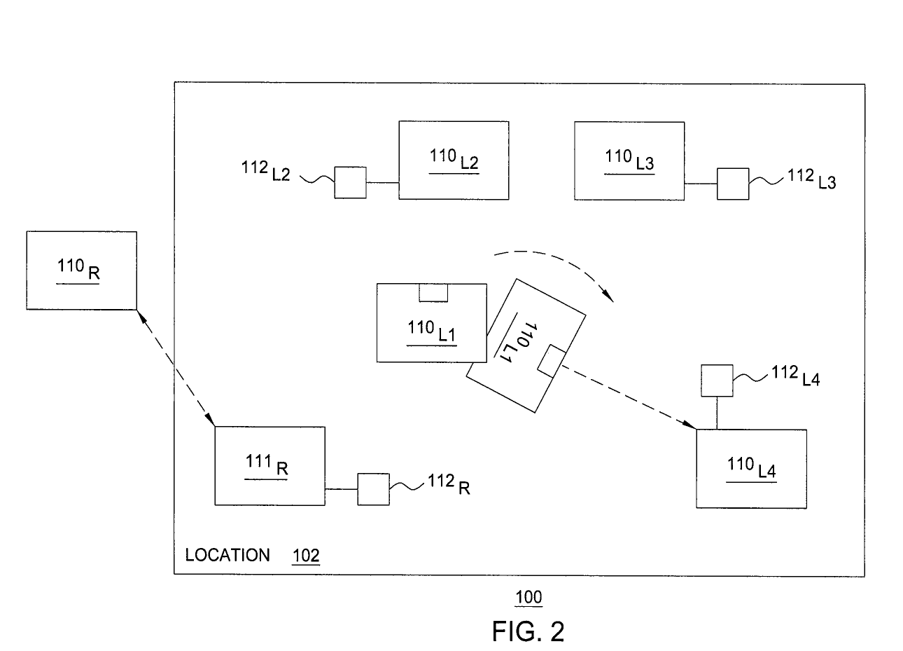

The use of spatial relationships between devices 110 and detection of gesture-based commands for coordinating transfer of information between devices 110 may be better understood with respect to the examples of FIG. 2-FIG. 5.

FIG. 2 depicts the environment of FIG. 1, illustrating an exemplary transfer of information between ones of the multiple devices. In the example of FIG. 2, a photograph is to be transferred from the coordinating device 110_{L1} to device 110_{L4}. The user requests that the photographs that are stored on the coordinating device 110_{L1} be displayed on a user interface of coordinating device 110_{L1} (e.g., in any manner by which a user may perform such an action). The user then points coordinating device 110_{L1} at device 110_{L4}. The coordinating device 110_{L1} is aware that it is pointed at device 110_{L4} (by way of respective devices 112_{L1} and 112_{L4}) and, therefore, is aware of the spatial relationship between coordinating device 110_{L1} and device 110_{L4}. The user then indicates, via a user interface of coordinating device 110_{L1}, that the user would like to transfer the selected photograph from coordinating device 110_{L1} to device 110_{L4} at which coordinating device 110_{L1} is pointed, (e.g., by pressing, on a user interface of the coordinating device 110_{L1}, an icon that is representative of the photograph; by selecting a “transfer” options from a drop down menu on coordinating device 110_{L1}; or in any other manner for initiating such a transfer). The coordinating device 110_{L1} then initiates a transfer of the photograph to device 110_{L4} (e.g., using a direct point-to-point connection between devices 110_{L4} and 110_{L3}, via a LAN to which both devices 110_{L4} and 110_{L3} are connected, via the Internet, or via any other manner by which the photograph may be propagated from the coordinating device 110_{L1} to device 110_{L4}). In this manner, the selected item is transferred between devices 110_{L1} and 110_{L4} based on the spatial relationship between coordinating device 110_{L1} and device 110_{L4} and the gesture-based command detected by coordinating device 110_{L1}.

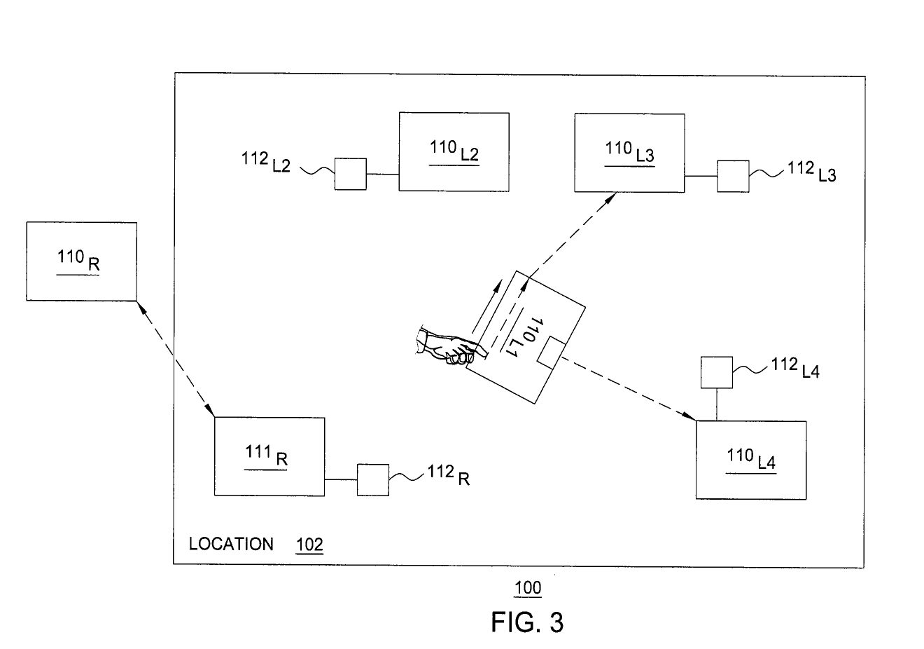

FIG. 3 depicts the environment of FIG. 1, illustrating an exemplary transfer of information between ones of the multiple devices. In the example of FIG. 3, a video clip is transferred from device 110_{L4} (computer) to device 110_{L3} (television) so that the user can view it on a larger screen. The user points coordinating device 110_{L1} in the direction of device 110_{L4} and initiates a request to review a list of items available from device 110_{L4} (e.g., by pressing an icon or button on a user interface of the coordinating device 110_{L1}, by selecting a “review available items” options from a drop down menu on coordinating device 110_{L1}, or in any other manner for initiating such a request). The coordinating device 110_{L1} then initiates, to the device 110_{L4}, a request for a list of items available from the device 110_{L4}. The request may be a generic request (e.g., for all content available from the device 110_{L4}) or a targeted request (e.g., for a specific subset of video clips available from the device 110_{L4}). The device 110_{L4} receives the request for the list of items available on device 110_{L4}. The device 110_{L4} responds to the request for the list of items by propagating, to coordinating device 110_{L1}, information about items available from device 110_{L4}. The coordinating device 110_{L1} receives the information about items available from device 110_{L4}. The list of items available from device 110_{L4} is displayed to the user of the coordinating device 110_{L1} via a user interface of coordinating device 110_{L1}. The user selects one of the available items by touching, on a touch screen of the coordinating device 110_{L1}, an icon representative of the item (e.g., using a stylus held by the user or a finger of the user). The user then slides the selected item in a particular direction on the touch screen of coordinating device 110_{L1} by sliding the stylus/finger across the touch screen. The user slides the selected item on the touch screen until the stylus/finger and, thus, the icon of the selected item, reaches one of the edges of the touch screen. In this example, with the coordinating device 110_{L1} still pointed at the device 110_{L4}, the user slides the selected item across the touch screen until it reaches the left edge of the touch screen (which is in the direction of devices 110_{L2} and 110_{L3}, i.e., the stereo and the television system, respectively). The coordinating device 110_{L1} determines, based on the spatial relationships between the devices 110 and the gesture-based command (including the orientation of coordinating device 110_{L1} and the direction of motion associated with sliding of the item across the touch screen of coordinating device 110_{L1} to the left edge of coordinating device 110_{L1}), that the user would like the item to be transferred to device 110_{L3}. The coordinating device 110_{L1} may determine that the video clip is not intended for device 110_{L2} because device 110_{L2} is a stereo that is incapable of presenting the selected video clip. The coordinating device 110_{L1} then initiates a control message adapted for triggering device 110_{L4} to provide the selected item to device 110_{L3}. The coordinating device 110_{L1} propagates the control message to device 110_{L4}. The device 110_{L4}, in response to the control message from coordinating device 110_{L1}, propagates the selected item to device 110_{L3} (e.g., via a direct point-to-point connection between devices 110_{L4} and 110_{L3}, via a LAN to which the devices 110_{L4} and 110_{L3} are connected, via the Internet, or using any other means by which the selected item may be propagated from device 110_{L4} to device 110_{L3}). In this manner, the selected item is transferred between devices 110_{L4} and 110_{L3} based on spatial relationship between devices 110 and the gesture-based command(s) detected by coordinating device 110_{L1}.

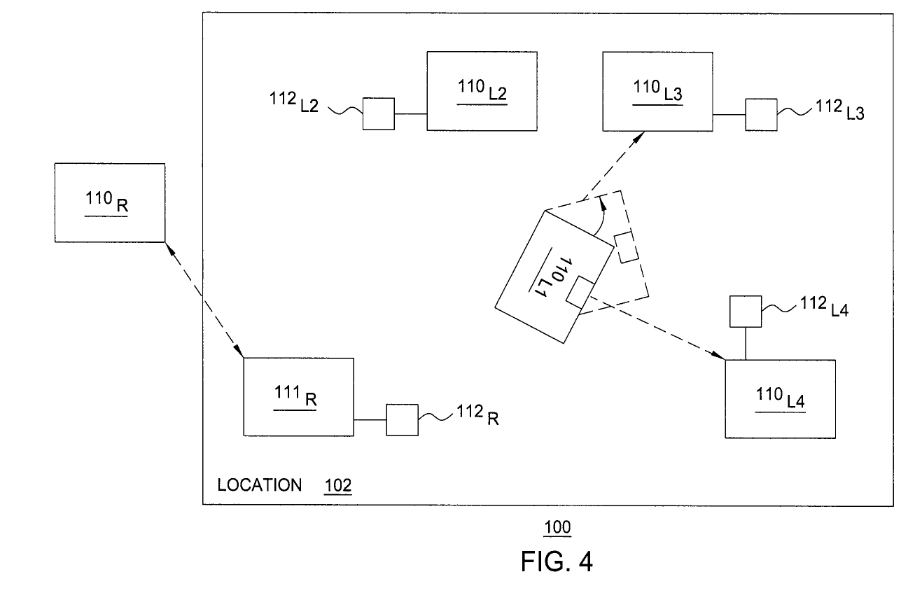

FIG. 4 depicts the environment of FIG. 1, illustrating an exemplary transfer of information between ones of the multiple devices. In the example of FIG. 4, an episode of a television program is transferred from device 110_{L4} (computer) to device 110_{L3} (television system) so that the user can watch the episode (e.g., that was obtained online after the user forgot to set the DVR to record the episode) on his television. The user points coordinating device 10_{L1} in the direction of device 110_{L4} and initiates a request to review a list of television program episodes available from device 110_{L4} (e.g., in any manner for initiating such a request via a user interface of coordinating device 110_{L1}). The coordinating device 110_{L1} then initiates, to the device 110_{L4}, a request for a list of television program episodes available from the device 110_{L4}. The device 110_{L4} receives the request for the list of television program episodes available on device 110_{L4}. The device 110_{L4} responds to the request for the list of television program episodes by propagating, to coordinating device 110_{L1}, information about television program episodes available from device 110_{L4}. The coordinating device 110_{L1} receives the information about television program episodes available from device 110_{L4}. The list of television program episodes available from device 110_{L4} is displayed to the user of coordinating device 110_{L1} via a user interface of coordinating device 110_{L1} The user selects one of the available television program episodes by touching, on a display screen of the coordinating device 110_{L1}, an icon representative of the item (e.g., using a stylus held by the user or a finger of the user). The user then waves or flicks the coordinating device 110_{L1} in the direction of device 110_{L3} (e.g., where coordinating device 110_{L1} includes an accelerometer or some other means of determining a direction of motion of coordinating device 110_{L1} when the user moves coordinating device 110_{L1}). The coordinating device 110_{L1} determines, based on the spatial relationships between the devices 110 and the gesture-based command (including the orientation of coordinating device 110_{L1} and the direction of motion associated with waving or flicking of the coordinating device 110_{L1} in the direction of device 110_{L3}), that the user would like the selected episode to be transferred from device 110_{L4} to device 110_{L3}. The coordinating device 110_{L1} then initiates a control message adapted for triggering device 110_{L4} to provide the selected item to device 110_{L3}. The coordinating device 110_{L1} propagates the control message to device 110_{L4}. The device 110_{L4}, in response to the control message from coordinating device 110_{L1}, propagates the selected episode to device 110_{L3} (e.g., via a direct point-to-point connection between devices 110_{L4} and 110_{L3}, via a LAN to which both devices 110_{L4} and 110_{L3} are connected, via the Internet, or in any other manner by which the selected item may be propagated from device 110_{L4} to device 110_{L3}). In this manner, the selected item is transferred between devices 110_{L4} and 110_{L3} based on the spatial relationship between devices 110 and the gesture-based command(s) detected by coordinating device 110_{L1}.

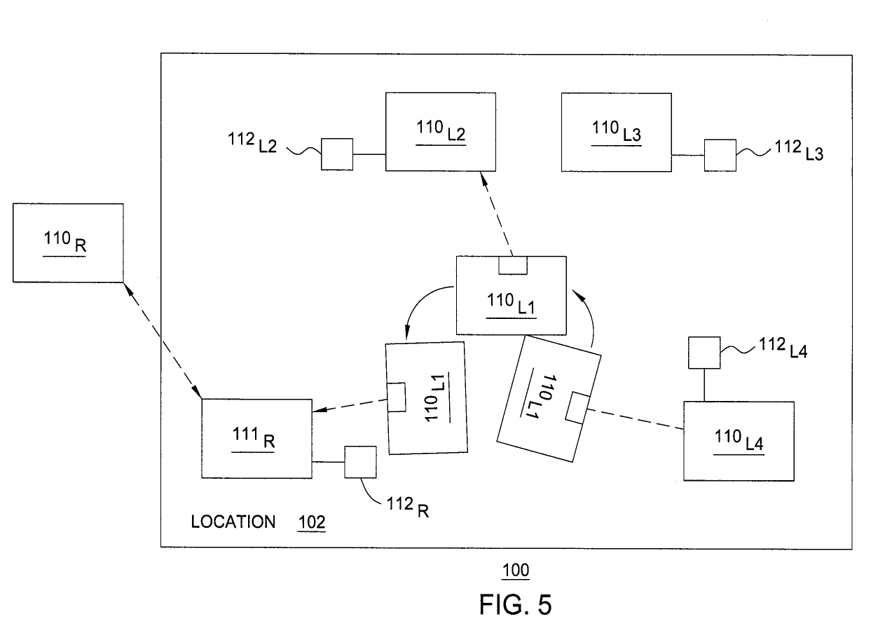

FIG. 5 depicts the environment of FIG. 1, illustrating an exemplary transfer of information between ones of the multiple devices. In the example of FIG. 5, a song is transferred from device 110_{L4} (computer) to devices 110_{L2} (stereo) and 110_{R} so that the user can listen to the song at home using the stereo and while in the office using the work computer. The user points coordinating device 110_{L1} in the direction of device 110_{L4} and initiates a request to review a list of songs available from device 110_{L4} (e.g., in any manner for initiating such a request via a user interface of coordinating device 110_{L1}). The coordinating device 110_{L1} then initiates, to the device 110_{L4}, a request for a list of songs available from the device 110_{L4}. The device 110_{L4} receives the request for the list of songs available on device 110_{L4}. The device 110_{L4} responds to the request for the list of songs by propagating, to coordinating device 110_{L1}, information about songs available from device 110_{L4}. The coordinating device 110_{L1} receives the information about songs available from device 110_{L4}. The list of songs available from device 110_{L4} is displayed to the user of the coordinating device 110_{L1} via a user interface of coordinating device 110_{L1}. The user then points coordinating device 110_{L1} at device 110_{L2} and indicates that device 110_{L2} is an intended target device to which the song should be transferred (e.g., by pressing, on a user interface of coordinating device 110_{L1}, an icon representative of the photograph; by selecting an option from a drop down menu on coordinating device 110_{L1}; or in any other manner for indicating such a selection). Additionally, the user then points coordinating device 110_{L1} at proxy object 111_{R} and indicates that remote device 110_{R}, which the proxy object 111_{R} is intended to represent, is an intended target device to which the song should be transferred (e.g., in any manner by which such a selection may be indicated). The coordinating device 110_{L1} is aware that it is pointed at device 110_{L2} and proxy object 111_{R} by way of respective devices 112_{L1}, 112_{L2}, and 112_{R}. The user then indicates, via a user interface of coordinating device 110_{L1}, that the user would like to transfer the selected song from source device 110_{L4} to the two indicated target devices 110_{L2} and 110_{R} by (e.g., by pressing, on a user interface of coordinating device 110_{L1}, an icon representative of the song; by selecting a “transfer” options from a drop down menu on coordinating device 110_{L1}; or in any other manner for initiating such a transfer). The coordinating device 110_{L1} then initiates a control message adapted for triggering device 110_{L4} to provide the selected item to devices 110_{L2} and 110_{R}. The device 110_{L4}, in response to the control message from coordinating device 110_{L1}, propagates the selected song to devices 110_{L2} and 110_{R} (e.g., via one or more of direct point-to-point connections, the Internet, or in any other manner by which the selected item may be propagated between devices). In this manner, the selected item is transferred from source device 110_{L4} to both target devices 110_{L2} and 110_{R} based on the spatial relationship between devices 110 and the gesture-based command(s) detected by coordinating device 110_{L1}.

In each of the examples depicted and described with respect to FIG. 2-FIG. 5, the selected item may be transferred from the source device to the target device(s) in any manner. For example, the item may be transferred using a direct point-to-point connection, a private network, a public network, and the like as well as various combinations thereof. For example, the item may be transferred using wireline and/or wireless communication capabilities. For example, the item may be downloaded from the source device to the target device(s), streamed from the source device to the target device(s), and the like, as well as various combinations thereof.

In each of the examples depicted and described with respect to FIG. 2-FIG. 5, the item that is transferred between devices 110 may be presented on the target device at the time at which the item is transferred to the target device and/or stored on the target device for later presentation to the user on the target device.

Although primarily depicted and described herein using examples in which information transfer coordination functions enable information to be transferred between typical communications devices (e.g., cellular phones, television systems, computers, and the like), information transfer coordination functions depicted and described herein may be utilized to enable transfers of information between various other devices that may include communications capabilities. For example, photographs may be transferred from a camera to a computer using a PDA as a coordinating device (i.e., without any manual interaction with the camera). For example, programs to control wash cycles on a washing machine may be transferred from a computer to the washing machine using a PDA as a coordinating device. For example, a grocery list may be transferred from a refrigerator (e.g., where the refrigerator has a scanner for scanning grocery items to form the grocery list) to a computer so that the user may print the grocery list to bring to the grocery store.

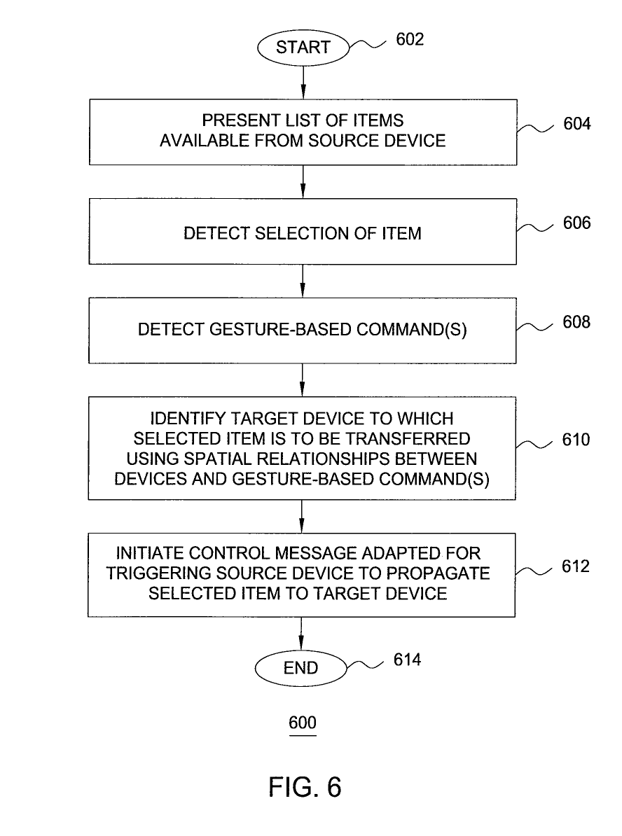

Thus, since the information transfer coordination functions depicted and described herein may be used to enable transfers of information between any devices supporting communications capabilities, a more general method of transferring information between devices is depicted and described herein in FIG. 6.

FIG. 6 depicts a method according to one embodiment of the present invention. Specifically, method 600 of FIG. 6 is a method for transferring information between devices using spatial relationships between the devices and one or more gesture-based commands. Although primarily depicted and described as being performed serially, at least a portion of the steps of method 600 may be performed contemporaneously, or in a different order than depicted and described with respect to FIG. 6. The method 600 begins at step 602 and proceeds to step 604.

At step 604, a list of available items is presented. The list of available items is presented on a coordinating device. The list of available items is a list of items available from a source device, which may be the coordinating device or another device. The presentation of the list of items may be provided as a result of one or more gesture-based commands.

At step 606, selection of one of the available items is detected. The selected item is selected via the coordinating device. The selected item is selected via a user interface of the coordinating device.

At step 608, a gesture-based command is detected. The gesture-based command may include one or more of pointing the coordinating device toward a target device and initiating an entry via a user interface of the coordinating device, generating a motion across a user interface of the coordinating device, moving the coordinating device, and the like, as well as various combinations thereof. The gesture-based command may be based on an orientation of the coordinating device when a selection is made.

At step 610, a target device to which the selected item is to be transferred is determined using spatial relationships between devices and the gesture-based command.

The spatial relationships between devices may be determined at any time. The spatial relationships may be determined continuously such that the spatial relationships between devices are available at the time at which the gesture-based command is detected. The spatial relationships between devices may be determined at the time at which the gesture-based command is detected. The determination of the spatial relationships between devices may be determined in many other ways.

At step 612, a control message is initiated. The control message is adapted for informing the source device that the selected item is to be transferred from the source device to the target device. The control message is generated and propagated internally within the coordinating device (where the coordinating device is the source device). The control message is generated by the coordinating device and propagated from the coordinating device to the source device (where the coordinating device is not the source device). The control message may indicate that the selected item is to be transferred immediately or at a later time.

At step 614, method 600 ends. Although depicted and described as ending (for purposes of clarity), method 600 may continue to be repeated to coordinate transfers of information between other combinations of devices.

Although primarily depicted and described herein with respect to use of gesture-based commands to specify a target device(s) to which information is to be transferred, one or more gesture-based commands also may be used to specify the source device(s) from which the information to be transferred is available. Thus, gesture-based commands and/or spatial relationships may be used in various ways to coordinate transfers of information between devices.

Although primarily depicted and described with respect to information transfer coordination capabilities, the functions depicted and described herein also may be utilized to provide information processing capabilities.

The processing of information may include any information processing capabilities.

The processing may include processing the information such that it may be presented via one or more user interfaces of a device. For example, where a movie being displayed on a television is moved to a mobile phone, the movie may be processed such that it may be displayed properly on the smaller screen of the mobile phone.

The processing may include processing the information such that the information is transcoded. For example, where an audio file being played on a mobile phone supporting a first audio encoding type is transferred to a stereo supporting a second audio encoding type, the audio file is transcoded from the first audio encoding type to the second audio encoding type. For example, where a video file being played on a mobile phone supporting a first video encoding type is transferred to a television supporting a second video encoding type, the video file is transcoded from the first video encoding type to the second video encoding type.

The processing may include printing information. For example, a user may move photographs from a camera to a computer so that the photographs may be printed by the computer. For example, a user may move a document from a home computer to a work computer so that the document may be printed by a printer associated with the work computer.

The processing may include changing the state of a device such that the device may process the information.

The processing capabilities may support various other types of processing.

In one embodiment, transfer of information between devices using the information transfer coordination capabilities may be performed within the context of processing of the information. For example, transfer of a television program from a television to a mobile phone may include transcoding of the television program from an encoding type supported by the television to an encoding type supported by the mobile phone. For example, a user may move a document from a home computer to a work computer such that the document may be printed by a printer associated with the work computer.

In one embodiment, for example, transfer of information between devices may be performed before or after processing of the information (i.e., such that transfer and processing of information may be considered to be performed serially). For example, information pre-processed on a first device may be transferred to a second device using information transfer coordination capabilities depicted and described herein. Similarly, for example, information may be transferred from a first device to a second device for post-processing of the information on the second device.

It will be understood that transfers and processing of information may be combined in various other ways to produce various other results. For example, information may be processed on a first device, moved to a second device for additional processing, and then processed while transferring the information from the second device to the third device to be stored on the third device.

Although primarily depicted and described herein with respect to transferring information between two devices, the information transfer coordination capabilities depicted and described herein may be used to transfer information from any number of source devices to any number of destination devices in any combination of such transfers.

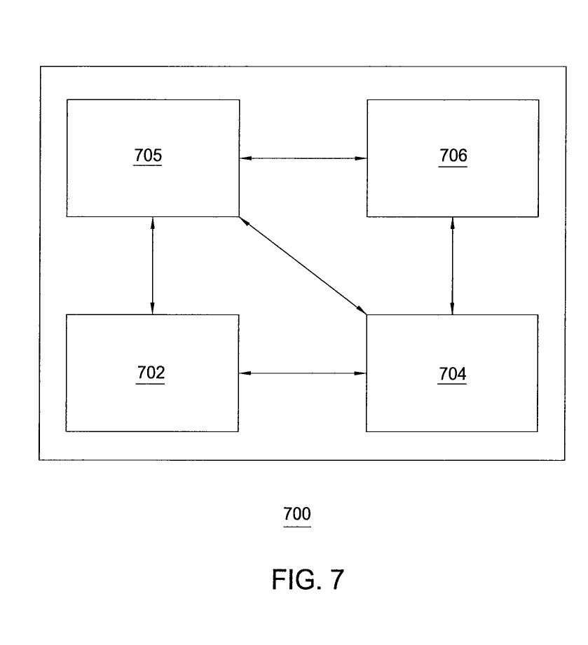

FIG. 7 depicts a high-level block diagram of a general-purpose computer suitable for use in performing the functions described herein. As depicted in FIG. 7, system 700 comprises a processor element 702 (e.g., a CPU), a memory 704, e.g., random access memory (RAM) and/or read only memory (ROM), an information transfer control module 705, and various input/output devices 706 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, a microphone, and the like)).

It should be noted that the present invention may be implemented in software and/or in a combination of software and hardware, e.g., using application specific integrated circuits (ASIC), a field programmable gate array (FPGA), a general purpose computer or any other hardware equivalents. In one embodiment, the information transfer control process 705 can be loaded into memory 704 and executed by processor 702 to implement the functions as discussed hereinabove. As such, information transfer control process 705 (including associated data structures) of the present invention can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory within a computing device operating according to the instructions.

The information transfer coordination functions carry the notion of service blending all the way to the end user by using the coordination device as the physical—and, therefore, the direct—embodiment of service blending functions in that the commands entered via the coordination device are the controls for service blending. The coordination device may be used as the control means for blending services from many application domains, thereby presenting end users with a common interface for controlling exchanges of information among various component services.

Although various embodiments which incorporate the teachings of the present invention have been shown and described in detail herein, those skilled in the art can readily devise many other varied embodiments that still incorporate these teachings.

What is claimed is:

1. A method for coordinating transfer of information between ones of a plurality of devices including a coordinating device and at least one other device, comprising:
detecting selection of an item available at a first one of the devices;
detecting a gesture-based command for the selected item;
identifying a second one of the devices based on the gesture-based command and a spatial relationship between the coordinating device and the second one of the devices; and
initiating a control message adapted for enabling the first one of the devices to propagate the selected item toward the second one of the devices.

2. The method of claim 1, wherein detecting the selection of an item available at a first one of the devices comprises:
detecting a gesture-based command.

3. The method of claim 2, wherein the gesture-based command by which the available item is selected comprises at least one of:
pointing the coordinating device toward the first one of the devices;
generating a motion across a user interface of the coordinating device; and
moving the coordinating device.

4. The method of claim 1, wherein detecting the selection of an item available at a first one of the devices comprises:
displaying the item at the coordinating device; and
detecting, at the coordinating device, a user input indicative of selection of the item.

5. The method of claim 1, wherein the first one of the devices is the coordinating device, and the item selected at the coordinating device is an item stored on the coordinating device.

6. The method of claim 1, wherein the item selected at the coordinating device is an item stored on the first one of the devices.

7. The method of claim 1, wherein the gesture-based command comprises at least one of:
pointing the coordinating device toward the second one of the devices;
generating a motion across a user interface of the coordinating device; and
moving the coordinating device.

8. The method of claim 7, wherein the motion across a user interface of the coordinating device comprises at least one of:
sliding a finger across a touch screen of the coordinating device; and
sliding a stylus across a touch screen of the coordinating device.

9. The method of claim 1, wherein the gesture-based command comprises at least one orientation parameter, the at least one orientation parameter specifying at least one of an orientation of the coordinating device with respect to the second one of the devices and an orientation of a motion by a user with respect to the second one of the devices.

10. The method of claim 1, further comprising:
determining spatial relationships between each of the devices, wherein the spatial relationships are determined using at least one of absolute spatial information and relational spatial information.

11. The method of claim 1, further comprising:
identifying the first one of the devices storing the available item.

12. The method of claim 11, wherein the first one of the devices is identified using at least one gesture-based command.

13. The method of claim 12, wherein the gesture-based command comprises at least one of:
pointing the coordinating device toward the first one of the devices;
generating a motion across a user interface of the coordinating device; and
moving the coordinating device.

14. The method of claim 1, further comprising:
propagating the control message from coordinating device toward the first one of the devices.

15. The method of claim 14, further comprising:
receiving the control message at the first one of the devices; and
in response to the control message, propagating the selected item from the first one of the devices toward the second one of the devices.

16. The method of claim 15, wherein the item is propagated from the first one of the devices toward the second one of the devices using at least one communication path, wherein the communication path uses at least one of a point-to-point connection, a local area network between the first and second ones of the devices, and the Internet.

17. The method of claim 1, wherein the item comprises at least one of a data item, a service, and an application.

18. The method of claim 1, wherein the first one of the devices and the second one of the devices are geographically co-located or geographically remote.

19. An apparatus for coordinating transfer of information between ones of a plurality of devices including a coordinating device and at least one other device, comprising:
means for detecting selection of an item available at a first one of the devices;
means for detecting a gesture-based command for the selected item;
means for identifying a second one of the devices based on the gesture-based command and a spatial relationship between the coordinating device and the second one of the devices; and
means for initiating a control message adapted for enabling the first one of the devices to propagate the selected item toward the second one of the devices.

20. A method for coordinating transfer of information between ones of a plurality of devices including a coordinating device and at least one other device, comprising:
detecting at least one gesture-based command identifying a first one of the devices storing an available item;
detecting selection of the available item;
detecting at least one gesture-based command identifying a second one of the devices to which the selected item is to be transferred; and
initiating a control message adapted for enabling the first one of the devices to propagate the selected item toward the second one of the devices.
